(19) United States
(12) Patent Application Publication
(10) Pub. No.: US 2010/0248699 A1
(43) Pub. Date: Sep. 30, 2010

(54) REMOTE APPLICATION STORAGE

(76) Inventor: Paul Mark Joseph DUMAIS, Nepean (CA)

Correspondence Address: Ridout & Maybee LLP, 225 King Street West, 10th Floor, Toronto, ON, M5V 3M2, CA

(21) Appl. No.: 12/703,272

(22) Filed: Feb. 10, 2010

Related U.S. Application Data
(60) Provisional application No. 61/165,152, filed on Mar. 31, 2009.

(51) Int. Cl. H04M 3/42

(52) U.S. Cl. 455/414.1

(57) ABSTRACT

A method, server and system for delivering an application are provided. In one example embodiment, the method comprises receiving application data associated with an application from a first mobile communication device; in response to receiving the application data, storing the application data in a memory; receiving a request for the application from a second mobile communication device which is associated with the first mobile communication device; and in response to receiving the request: retrieving the application associated with the request; sending the application to the second mobile communication device; retrieving the application data associated with the application; and sending the application data to the second mobile communication device.

### TECHNICAL FIELD

The present disclosure relates generally to application delivery systems and, more particularly to a method, server and system for remotely storing and delivering applications for use on a mobile communication device.

### BACKGROUND

Mobile communication devices typically have limited memory available for storage. This memory may be occupied, for example, by data such as service data including information required by the mobile communication device to establish and maintain communication with a wireless network, user application data such as email messages, address book and contact information, calendar and schedule information, notepad documents, image files, and other commonly stored user information.

The memory may also have applications stored thereon such as, for example, instant messaging applications, email applications, word processing applications, media player applications, games, etc. Some of these applications may be loaded by the manufacturer of the mobile device or a service provider associated with the mobile device. In other cases, the applications may be loaded onto the mobile device by the user.

Due to the limited amount of memory available, the mobile communication device may run out of memory.

### BRIEF DESCRIPTION OF THE DRAWINGS

FIG. 1 is a block diagram illustrating a communication system including a mobile communication device and an application delivery server to which example embodiments of the present disclosure can be applied;

FIG. 2 is a block diagram illustrating the mobile communication device of FIG. 1 in accordance with one example embodiment of the present disclosure;

FIG. 3 is a block diagram illustrating the application delivery server of FIG. 1 in accordance with one example embodiment of the present disclosure;

FIG. 4 is a flowchart illustrating a method for obtaining and delivering a software application in accordance with example embodiments of the present disclosure;

FIG. 5 is a flowchart illustrating a method for re-delivering a software application in accordance with example embodiments of the present disclosure;

FIG. 6 is a flowchart illustrating a method for backing up application data in accordance with example embodiments of the present disclosure; and

FIG. 7 is a flowchart illustrating a method for re-delivering a software application in accordance with example embodiments of the present disclosure.

Like reference numerals are used in the drawings to denote like elements and features.

### DETAILED DESCRIPTION OF EXAMPLE EMBODIMENTS

In one example embodiment, the present application provides a method of delivering an application from an application delivery server. The method includes: receiving application data associated with an application from a first mobile communication device (also referred to herein as a mobile device); in response to receiving the application data, storing the application data in a memory; receiving a request for the application from a second mobile communication device which is associated with the first mobile communication device; and in response to receiving the request: retrieving the application associated with the request; sending the application to the second mobile communication device; retrieving the application data associated with the application; and sending the application data to the second mobile communication device.

In another example embodiment, the present application provides an application delivery server. The application delivery server includes a communication subsystem for communicating with at least one mobile communication device. The application delivery server further includes at least one memory for storing one or more applications and for storing application data and at least one controller for controlling the operation of the application delivery server. The at least one controller is configured to: receive application data associated with one of more of the applications from one of the mobile communication devices; in response to receiving the application data, store the application data in memory; receive a request for one of the applications from one of the mobile communication devices; and in response to receiving the request: retrieve the application associated with the request; send the application to the mobile communication device; retrieve application data associated with the application; and send the application data to the mobile communication device.

In another example embodiment, the present application provides a mobile communication device (also referred to herein as a mobile device). The mobile communication device includes a communication subsystem for communicating with an application delivery server. The mobile communication device further includes a display, a memory, and an input mechanism for receiving a request to download a previously downloaded application. The mobile communication device further includes a controller for controlling the operation of the mobile communication device and an application store client associated with the controller. The application store client is configured to: receive data identifying previously downloaded applications available for re-download; and display at least some of the data identifying one or more of the previously downloaded application available for re-download.

In another example embodiment, the present application provides a method of obtaining a licensed application on an electronic device including: receiving, at a mobile communication device, data identifying previously downloaded applications available for re-download; displaying, on a display screen associated with the mobile communication device, at least some of the data identifying one or more of the previously downloaded application available for re-download; receiving a request for re-downloading an application available for re-download from an input mechanism associated with the device; transmitting a request to re-download the application to the application delivery server; and receiving the requested application.

In yet another example embodiment, the present application provides an application delivery server. The application delivery server includes a communication subsystem for communicating with a mobile communication device and a memory for storing applications and for storing data identifying previously downloaded applications available for re-download. The application delivery server further includes at least one controller for controlling the operation of the application delivery server. The at least one controller is configured to: identify applications available for re-download to the mobile communication device; transmit the data identifying applications available for re-download; receive a request for re-downloading an application from the mobile communication device; retrieve an application associated with the request; and transmit the application to the mobile communication device.

In yet another example embodiment, the present application provides a computer program product including a computer readable medium having encoded thereon computer executable instructions for remotely storing applications. The computer program product includes: computer executable instructions for receiving, at a mobile communication device, data identifying previously downloaded applications available for re-download; computer executable instructions for displaying, on a display screen associated with the mobile communication device, at least some of the data identifying one or more of the previously downloaded application available for re-download; computer executable instructions for receiving a request for re-downloading an application available for re-download from an input mechanism associated with the device; computer executable instructions for transmitting a request to re-download the application to the application delivery server; and computer executable instructions for receiving the requested application.

In yet a further example embodiment, the present application provides a method of re-downloading an application including: identifying applications available for re-download to a mobile communication device; transmitting data identifying applications available for re-download to the mobile communication device; receiving a request for re-downloading an application from the mobile communication device; retrieving an application associated with the request; and transmitting the retrieved application to the mobile communication device.

Other example embodiments of the present application will be apparent to those of ordinary skill in the art from a review of the following detailed description in conjunction with the drawings.

Example embodiments of the present application are not limited to any particular operating system, mobile device architecture, server architecture, or computer programming language.

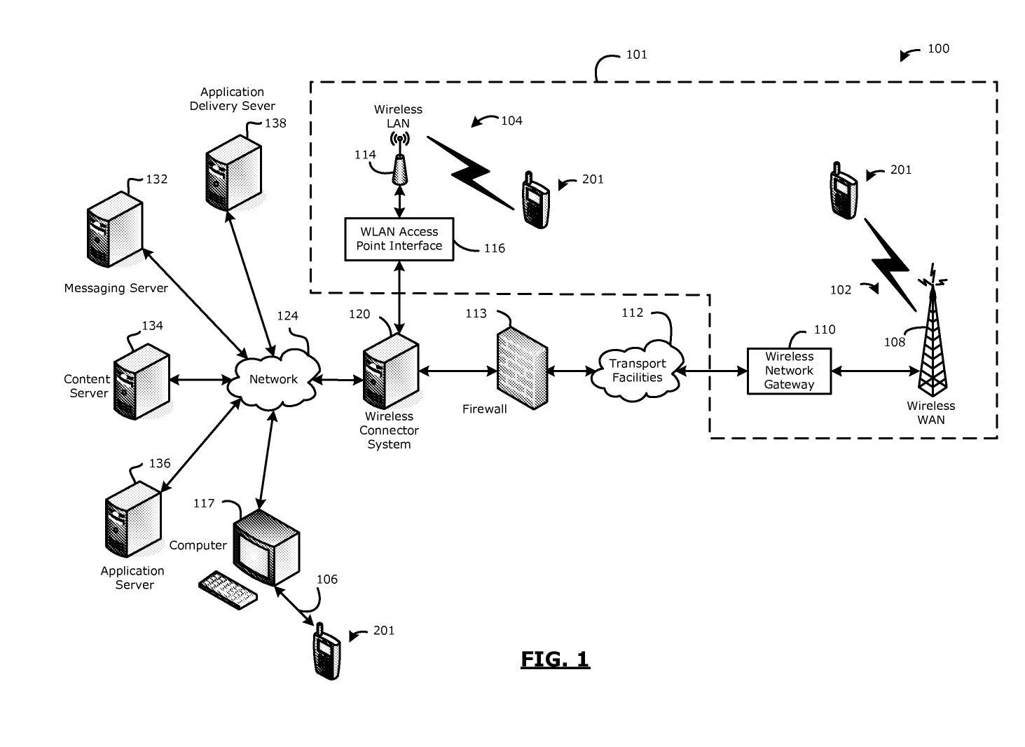

In order to facilitate an understanding of one possible environment in which example embodiments described herein can operate, reference is first made to FIG. 1 which shows in block diagram form a communication system 100 in which example embodiments of the present disclosure can be applied. The communication system 100 includes a number of mobile communication devices 201 which may be connected to the remainder of the system 100 in any of several different ways. Accordingly, several instances of mobile communication devices 201 are depicted in FIG. 1 employing different example ways of connecting to system 100. Mobile communication devices 201 are connected to a wireless network 101 which may include one or more of a Wireless Wide Area Network (WWAN) 102 and a Wireless Local Area Network (WLAN) 104 or other suitable network arrangements. In some example embodiments, the mobile communication devices 201 are configured to communicate over both the WWAN 102 and WLAN 104, and to roam between these networks. In some example embodiments, the wireless network 101 may include multiple WWANs 102 and WLANs 104.

The WWAN 102 may be implemented as any suitable wireless access network technology. By way of example, but not limitation, the WWAN 102 may be implemented as a wireless network that includes a number of transceiver base stations 108 (one of which is shown in FIG. 1) where each of the base stations 108 provides wireless Radio Frequency (RF) coverage to a corresponding area or cell. The WWAN 102 is typically operated by a mobile network service provider that provides subscription packages to users of the mobile communication devices 201. In some example embodiments, the WWAN 102 conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA2000, EDGE (Enhanced Data rates for GSM Evolution), UMTS (Universal Mobile Telecommunication Systems), HSPDA (High-Speed Downlink Packet Access), IEEE 802.16e (also referred to as Worldwide Interoperability for Microwave Access or “WiMAX), or various other networks. Although WWAN 102 is described as a “Wide-Area” network, that term is intended herein also to incorporate wireless Metropolitan Area Networks (WMAN) and other similar technologies for providing coordinated service wirelessly over an area larger than that covered by typical WLANs.

The WWAN 102 may further include a wireless network gateway 110 which connects the mobile communication devices 201 to transport facilities 112, and through the transport facilities 112 to a wireless connector system 120. Transport facilities may include one or more private networks or lines, the public Internet, a virtual private network, or any other suitable network. The wireless connector system 120 may be operated, for example, by an organization or enterprise such as a corporation, university, or governmental department, which allows access to a network 124 such as an internal or enterprise network and its resources, or the wireless connector system 120 may be operated by a mobile network provider. In some example embodiments, the network 124 may be realised using the Internet rather than an internal or enterprise network.

The wireless network gateway 110 provides an interface between the wireless connector system 120 and the WWAN 102, which facilitates communication between the mobile communication devices 201 and other devices (not shown) connected, directly or indirectly, to the WWAN 102. Accordingly, communications sent via the mobile communication devices 201 are transported via the WWAN 102 and the wireless network gateway 110 through transport facilities 112 to the wireless connector system 120. Communications sent from the wireless connector system 120 are received by the wireless network gateway 110 and transported via the WWAN 102 to the mobile communication devices 201.

The WLAN 104 includes a wireless network which, in some example embodiments, conforms to IEEE 802.11x standards (sometimes referred to as Wi-Fi) such as, for example, the IEEE 802.11a, 802.11b and/or 802.11g standard. Other communication protocols may be used for the WLAN 104 in other example embodiments such as, for example, IEEE 802.11n, IEEE 802.16e (also referred to as Worldwide Interoperability for Microwave Access or “WiMAX”), or IEEE 802.20 (also referred to as Mobile Wireless Broadband Access). The WLAN 104 includes one or more wireless RF Access Points (AP) 114 (one of which is shown in FIG. 1) that collectively provide a WLAN coverage area.

The WLAN 104 may be a personal network of the user, an enterprise network, or a hotspot offered by an Internet service provider (ISP), a mobile network provider, or a property owner in a public or semi-public area, for example. The access points 114 are connected to an access point (AP) interface 116 which may connect to the wireless connector system 120 directly (for example, if the access point 114 is part of an enterprise WLAN 104 in which the wireless connector system 120 resides), or indirectly via the transport facilities 112 if the access point 114 is a personal Wi-Fi network or Wi-Fi hotspot (in which case a mechanism for securely connecting to the wireless connector system 120, such as a virtual private network (VPN), may be used). The AP interface 116 provides translation and routing services between the access points 114 and the wireless connector system 120 to facilitate communication, directly or indirectly, with the wireless connector system 120.

The wireless connector system 120 may be implemented as one or more servers, and is typically located behind a firewall 113. The wireless connector system 120 manages communications, including email communications, to and from a set of managed mobile communication devices 201. The wireless connector system 120 also provides administrative control and management capabilities over users and mobile communication devices 201 which may connect to the wireless connector system 120.

The wireless connector system 120 allows the mobile communication devices 201 to access the network 124 and connected resources and services such as a messaging server 132 (for example, a Microsoft Exchange™, IBM Lotus Domino™, or Novell GroupWise™ email server), and a content server 134 for providing content such as Internet content or content from an organization's internal servers, and application servers 136 for implementing server-based applications such as instant messaging (IM) applications to mobile communication devices 201.

The wireless connector system 120 also allows the mobile communication devices 201 to access an application delivery server 138. The application delivery server 138 is configured to deliver applications to the mobile devices 201 upon request by the mobile device 201. Applications are programs that include instructions for the mobile device 201 which provide a user of the mobile device 201 with tools to accomplish a task. By way of non-limiting example, the applications may include word processions applications, media player applications, database applications, games, etc. The application delivery server 138 may be configured to act as a remote storage facility for the mobile device 201 to permit users of the mobile communication devices 201 to re-download applications that were previously downloaded, purchased and/or otherwise acquired. In at least some example embodiments, the application delivery server 138 acts as, or interfaces with an application data backup server and is configured to store application data. Application data is data which is used by an application and which is, generally, user or device specific data. The application data may, in various embodiments, include user settings or preferences associated with an application, user achievements (i.e. high scores associated with a game), etc. The application data is, in at least some embodiments, configured or created by a user of the mobile device 201.

The wireless connector system 120 typically provides a secure exchange of data (e.g., email messages, personal information manager (PIM) data, and IM data) with the mobile communication devices 201. In some example embodiments, communications between the wireless connector system 120 and the mobile communication devices 201 are encrypted. In some example embodiments, communications are encrypted using a symmetric encryption key implemented using Advanced Encryption Standard (AES) or Triple Data Encryption Standard (Triple DES) encryption. Private encryption keys are generated in a secure, two-way authenticated environment and are used for both encryption and decryption of data. In some example embodiments, the private encryption key is stored only in the user's mailbox on the messaging server 132 and on the mobile communication device 201, and can typically be regenerated by the user on mobile communication devices 201. Data sent to the mobile communication devices 201 is encrypted by the wireless connector system 120 using the private encryption key retrieved from the user's mailbox. The encrypted data, when received on the mobile communication devices 201, is decrypted using the private encryption key stored in memory. Similarly, data sent to the wireless connector system 120 from the mobile communication devices 201 is encrypted using the private encryption key stored in the memory of the mobile communication device 201. The encrypted data, when received on the wireless connector system 120, is decrypted using the private encryption key retrieved from the user's mailbox.

The wireless network gateway 110 is adapted to send data packets received from the mobile communication device 201 over the WWAN 102 to the wireless connector system 120. The wireless connector system 120 then sends the data packets to the appropriate connection point such as the messaging server 132, content server 134, application delivery server 138 or application servers 136. Conversely, the wireless connector system 120 sends data packets received, for example, from the messaging server 132, content server 134, application delivery server 138 or application servers 136 to the wireless network gateway 110 which then transmit the data packets to the destination mobile communication device 201. The AP interfaces 116 of the WLAN 104 provide similar sending functions between the mobile communication device 201, the wireless connector system 120 and network connection point such as the messaging server 132, content server 134, application delivery server 138 and application server 136.

The network 124 may include a private local area network, metropolitan area network, wide area network, the public Internet or combinations thereof and may include virtual networks constructed using any of these, alone, or in combination.

A mobile communication device 201 may alternatively connect to the wireless connector system 120 using a computer 117, such as desktop or notebook computer, via the network 124. A link 106 may be provided for exchanging information between the mobile communication device 201 and computer 117 connected to the wireless connector system 120. The link 106 may include one or both of a physical interface and short-range wireless communication interface. The physical interface may include one or combinations of an Ethernet connection, Universal Serial Bus (USB) connection, Firewire™ (also known as an IEEE 1394 interface) connection, or other serial data connection, via respective ports or interfaces of the mobile communication device 201 and computer 117. The short-range wireless communication interface may be a personal area network (PAN) interface. A personal area network is a wireless point-to-point connection meaning no physical cables are required to connect the two end points. The short-range wireless communication interface may include one or a combination of an infrared (IR) connection such as an Infrared Data Association (IrDA) connection, a short-range radio frequency (RF) connection such as one specified by IEEE 802.15.1 or the Bluetooth™ special interest group, or IEEE 802.15.3a, also referred to as UltraWideband (UWB), or other PAN connection.

It will be appreciated that the above-described communication system is provided for the purpose of illustration only, and that the above-described communication system includes one possible communication network configuration of a multitude of possible configurations for use with the mobile communication devices 201. The teachings of the present disclosure may be employed in connection with other types of networks and associated devices that are effective in implementing or facilitating wireless communication. Suitable variations of the communication system will be understood to a person of skill in the art and are intended to fall within the scope of the present disclosure.

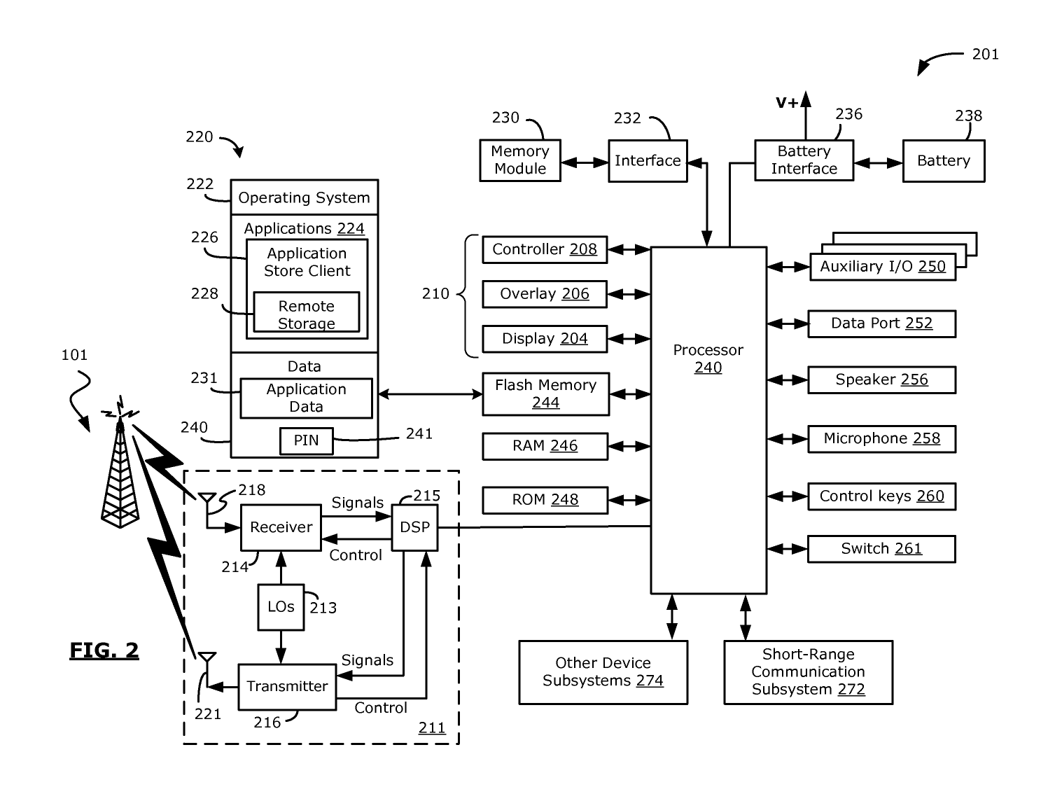

Reference is now made to FIG. 2 which illustrates a mobile communication device 201 in which example embodiments described in the present disclosure can be applied. The mobile communication device 201 is a two-way communication device having at least data and possibly also voice communication capabilities, and the capability to communicate with other computer systems, for example, via the Internet. Depending on the functionality provided by the mobile communication device 201, in various example embodiments the mobile device 201 may be a data communication device, a multiple-mode communication device configured for both data and voice communication, a smartphone, a mobile telephone or a PDA (personal digital assistant) enabled for wireless communication, or a computer system with a wireless modem.

The mobile communication device 201 includes a controller including at least one processor 240 such as a microprocessor which controls the overall operation of the mobile communication device 201, and a wireless communication subsystem 211 for exchanging radio frequency signals with the wireless network 101. The processor 240 interacts with the communication subsystem 211 which performs communication functions. The processor 240 interacts with additional device subsystems. In some example embodiments, the mobile device 201 may include a touchscreen display 210 which includes a display (screen) 204, such as a liquid crystal display (LCD) screen, with a touch-sensitive input surface or overlay 206 connected to an electronic controller 208. The touch-sensitive overlay 206 and the electronic controller 208 act as an input mechanism to provide a touch-sensitive input device. The processor 240 also interacts with the touch-sensitive overlay 206 via the electronic controller 208. In other example embodiments, the display 204 may not be a touchscreen display. Instead, the mobile device 201 may simply include a non-touch display and one or more input mechanisms, such as, for example, a depressible scroll wheel.

The processor 240 interacts with additional device subsystems including flash memory 244, random access memory (RAM) 246, read only memory (ROM) 248, auxiliary input/output (I/O) subsystems 250, data port 252 such as serial data port, such as a Universal Serial Bus (USB) data port, speaker 256, microphone 258, control keys 260, switch 261, short-range communication subsystem 272, and other device subsystems generally designated as 274. Some of the subsystems shown in FIG. 2 perform communication-related functions, whereas other subsystems may provide “resident” or on-device functions.

The communication subsystem 211 includes a receiver 214, a transmitter 216, and associated components, such as one or more antenna elements 218 and 221, local oscillators (LOs) 213, and a processing module such as a digital signal processor (DSP) 215. The antenna elements 218 and 221 may be embedded or internal to the mobile communication device 201 and a single antenna may be shared by both receiver and transmitter, as is known in the art. As will be apparent to those skilled in the field of communication, the particular design of the communication subsystem 211 depends on the wireless network 101 in which the mobile communication device 201 is intended to operate.

The mobile communication device 201 may communicate with any one of a plurality of fixed transceiver base stations 108 (FIG. 1) of the wireless network 101 within its geographic coverage area. The mobile communication device 201 may send and receive communication signals over the wireless network 101 after a network registration or activation procedures have been completed. Signals received by the antenna 218 through the wireless network 101 are input to the receiver 214, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 215. In a similar manner, signals to be transmitted are processed, including modulation and encoding, for example, by the DSP 215. These DSP-processed signals are input to the transmitter 216 for digital-to-analog (D/A) conversion, frequency up conversion, filtering, amplification, and transmission to the wireless network 101 via the antenna 221. The DSP 215 not only processes communication signals, but may also provide for receiver and transmitter control. For example, the gains applied to communication signals in the receiver 214 and the transmitter 216 may be adaptively controlled through automatic gain control algorithms implemented in the DSP 215.

The processor 240 operates under stored program control and executes software modules 220 stored in memory such as persistent memory, for example, in the flash memory 244. As illustrated in FIG. 2, the software modules 220 include operating system software 222, software applications 224 which include an application store client 226 for requesting and receiving software applications from the application delivery server 138 (FIG. 1) and interacting with the application delivery server 138 to provide remote application storage capabilities to the mobile device 201. The application store client 226 permits users of the mobile communication device 201 to connect to the application delivery server 138 and to browse or search for applications available for download to their mobile communication device 201. The application store client 226 permits users to purchase applications for use on their mobile device 201.

A user of the mobile communication device 201 may request an application from the application delivery server 138 by interacting with the application store client 226 on the mobile device; for example, by using the touchscreen display 210, control keys 260 or other input mechanism. In response to receiving a request to download an application from the user, the application store client 226 of the mobile communication device 201 may transmit a download request to the application delivery server 138 and wait for the application delivery server 138 to transmit the specified application to the mobile device 201. The mobile device 201 receives the application from the application delivery server 138. In some example embodiments, the application may require installation onto the mobile device 201 before it may be used. In such cases the application may be installed to the mobile device 201. Later, the application may be removed from the mobile device 201. For example, at the request of the user the application may be uninstalled. After such deletion, the application can subsequently be retrieved and installed using the remote storage module 228 of the mobile device 201.

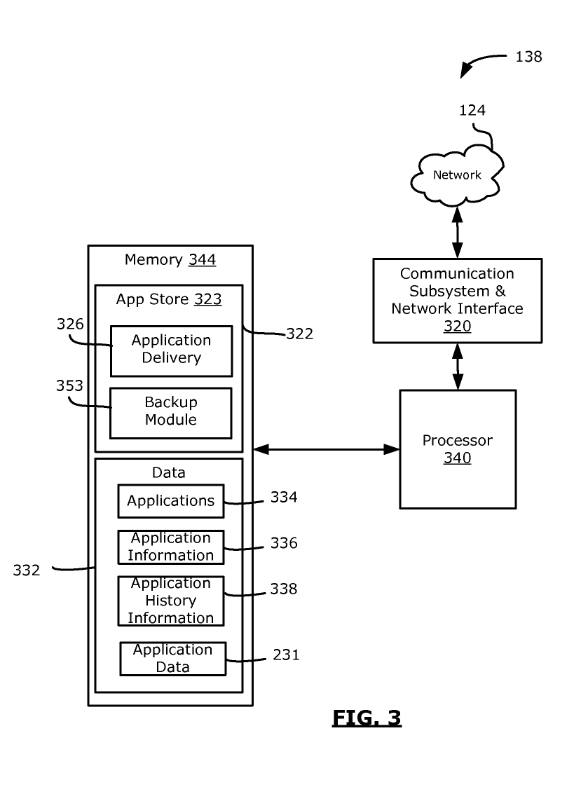

In at least some example embodiments, when the application is removed from the mobile device 201 (for example, when it is deleted by the user), application data 231 associated with that application may be transmitted to a remote server, such as the application delivery server 138. The application delivery server 138 may store the application data 231 in a memory 344 (FIG. 3). In some example embodiments, the application data 231 may be retrieved from the server and restored on the mobile device 201 if and when the application is retrieved.

The remote storage module 228 is configured to interact with the application delivery server 138 to provide remote storage capabilities for the mobile device. To provide such capabilities, the remote storage module 228 may be configured to transmit identification information to the application delivery server 138. The remote storage capabilities may be related to either a user, account, or, in some example embodiments, a specific device. The identification information may, in some example embodiments, identify the mobile device 201. For example, the identification information may be a Personal Identification Number (“PIN”) 241 associated with the mobile device 201. In other example embodiments, the identification information may identify a user or account associated with the mobile device 201. For example, the identification information may include one or more of a username and/or password, log-in information associated with the user or account, a unique identification number associated with the user or account, or an email address associated with the user or account.

The application delivery server 138 may determine, from the identification data, any applications that are available for re-download and may transmit data identifying these applications to the mobile device 201.

The applications which are said to be available for re-download may, in some example embodiments, be applications which were previously downloaded by either the mobile device 201 or by another mobile device associated with the same user. In some example embodiments, the applications which are said to be available for re-download are applications which the user of the mobile device 201 has previously purchased.

In at least one mode, the remote storage module 228 of the mobile device 201 is configured to display, on the display screen 204, data received from the application delivery server 138 which identifies at least one application available for re-download. For example, it may display data identifying one or more previously downloaded applications which are available for re-download to the mobile device. The displayed data may be presented in a list format in some example embodiments. The list may include two or more applications which are available for re-download to the mobile device 201.

In some example embodiments, a user may request that an application be re-downloaded to the mobile device 201 using an input mechanism associated with the mobile device; for example, the touchscreen display 210 or the control keys 260. The user may navigate, through a display screen containing a plurality of applications available for re-download, to a desired application available for re-downloading and select a “download” or other option to initiate the re-downloading of the application.

Upon receiving a user input to re-download an application, the remote storage module 228 of the application store client 226 transmits a request to the application delivery server 138 to request the delivery of the application. The request includes an identifier, such as a product number, associated with the application which permits the application delivery server 138 to determine the application that the request relates to. The application delivery server 138 may then cause the application to be transmitted and the application is received at the mobile communication device. In some example embodiments, the application may be automatically installed following its receipt.

The remote storage module 228 may, in some example embodiments, be launched from within the application store client 226. That is, the user may load the application store client 226 and may select an option to load the remote storage module 228 portion of the application store client 226. For example, the user may select an option entitled “Digital Storage Locker”, “Remote Applications”, “Previously Downloaded Applications” or “My World™” or an option with another similar descriptor. In other example embodiments, the remote storage module 228 may be a stand-alone component that is operationally separate from the application store client 226 and that is loadable by selecting an appropriate icon in an icon grid on a home page associated with the mobile device 201.

The application store client 226 and the remote storage module 228 may, among other things, be implemented through stand-alone software applications, or combined together in one or more of the operating system 222 and applications 224. In some example embodiments, the functions performed by the above identified applications 224 may be realized as a plurality of independent elements, rather than a single integrated element, and any one or more of these elements may be implemented as parts of other software applications.

Those skilled in the art will appreciate that the software modules 220 or parts thereof may be temporarily loaded into volatile memory such as the RAM 246. The RAM 246 is used for storing runtime data variables and other types of data or information, as will be apparent to those skilled in the art. Although specific functions are described for various types of memory, this is merely one example, and those skilled in the art will appreciate that a different assignment of functions to types of memory could also be used.

The software applications 224 may include a range of other applications, including, for example, an address book application, a messaging application, a calendar application, and/or a notepad application. In some example embodiments, the software applications 224 include an email message application, a push content viewing application, a voice communication (i.e. telephony) application, a map application, and a media player application. Each of the software applications 224 may include layout information defining the placement of particular fields and graphic elements (e.g. text fields, input fields, icons, etc.) in the user interface (i.e. the display device 204) according to the application.

In some embodiments, the auxiliary input/output (I/O) subsystems 250 may include an external communication link or interface, for example, an Ethernet connection. The mobile communication device 201 may include other wireless communication interfaces for communicating with other types of wireless networks, for example, a wireless network such as an orthogonal frequency division multiplexed (OFDM) network or a GPS transceiver for communicating with a GPS satellite network (not shown). The auxiliary I/O subsystems 250 may include a vibrator for providing vibratory notifications in response to various events on the mobile communication device 201 such as receipt of an electronic communication or incoming phone call, or for other purposes such as haptic feedback (touch feedback).

In some example embodiments, the mobile communication device 201 also includes a removable memory module 230 (typically including flash memory, such as a removable memory card) and a memory interface 232. Network access may be associated with a subscriber or user of the mobile communication device 201 via the memory module 230, which may be a Subscriber Identity Module (SIM) card for use in a GSM network or other type of memory card for use in the relevant wireless network type. The memory module 230 is inserted in or connected to the memory card interface 232 of the mobile communication device 201 in order to operate in conjunction with the wireless network 101.

The mobile communication device 201 stores data 240 in an erasable persistent memory, which in one example embodiment is the flash memory 244. In various example embodiments, the data 240 includes service data including information required by the mobile communication device 201 to establish and maintain communication with the wireless network 101. The data 240 may also include user application data 231 such as email messages, address book and contact information, calendar and schedule information, notepad documents, image files, and other commonly stored user information stored on the mobile communication device 201 by its user, and other data. The data 240 stored in the persistent memory (e.g. flash memory 244) of the mobile communication device 201 may be organized, at least partially, into a number of databases each containing data items of the same data type or associated with the same application. For example, email messages, contact records, and task items may be stored in individual databases within the mobile device memory. The application data 231 may include application data 231 which is associated with a specific application. For example, an application which is a game may have associated application data 231 specifying high scores, etc.

In some example embodiments, the data 240 may include identification data such as a Personal Identification Number (“PIN”) 241 identifying either the user or the mobile device. In some example embodiments, the PIN is a unique identifier assigned to the mobile communication device 201 during manufacturing of that device 201. The PIN may be saved in non-volatile memory so that the mobile device will retain the PIN even when it is powered off. In some example embodiments the identification data, such as the PIN 241 may be transmitted to the application delivery server 138 as part of the purchase, download, or re-download method associated with the delivery and subsequent re-delivery of an application from the application delivery server 138 to the mobile communication device 201.

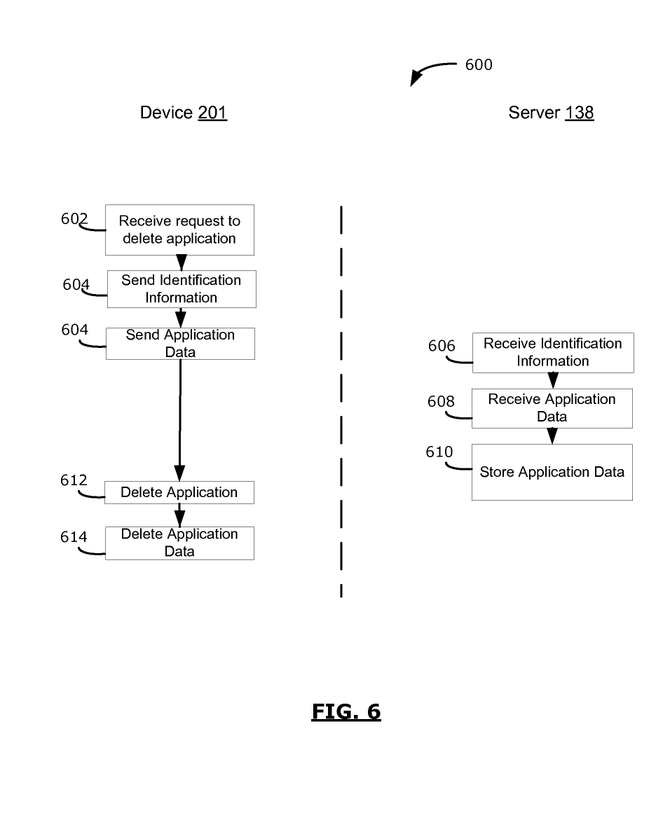

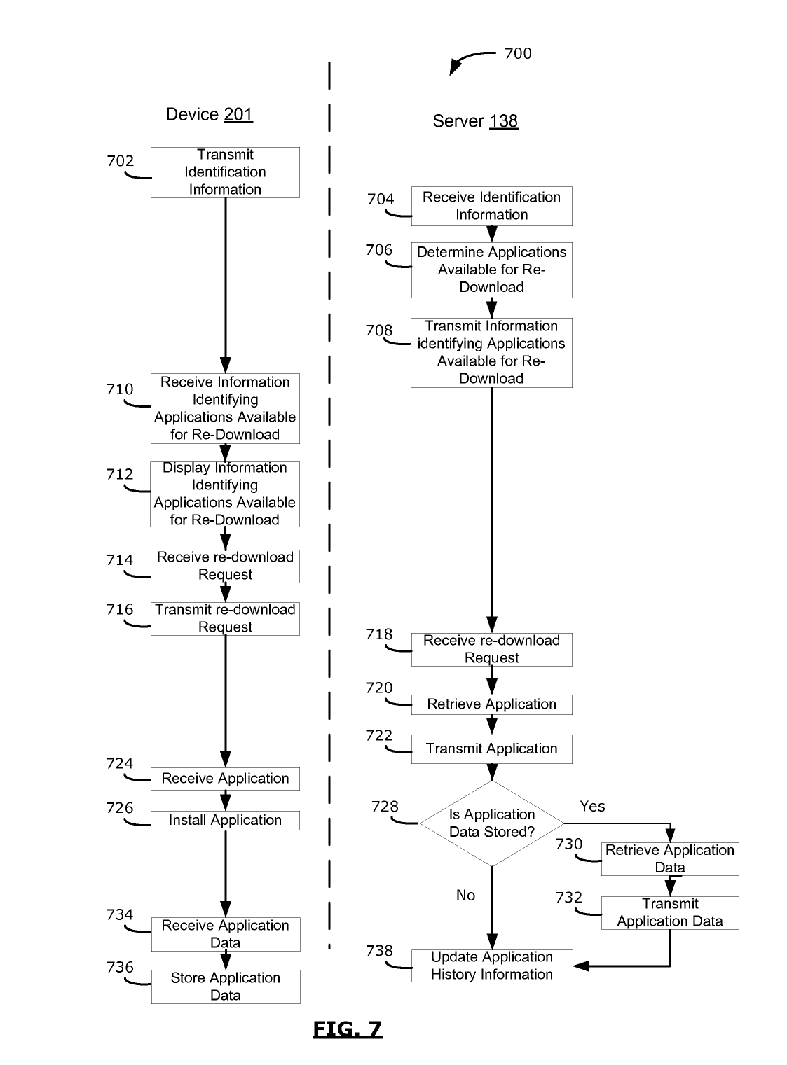

As will be explained in greater detail below with respect to FIGS. 6 and 7, in some example embodiments, the remote storage module 228 may provide for the backup and restoration of application data 231. Application data 231 may be backed up to a remote server; such as, for example, the application delivery server 138. That is, the mobile device 201 may transfer application data 231 associated with one or more application to the application delivery server 138.

In one embodiment, when a request to remove an application from the mobile device 201 is received (for example, via an input mechanism), the remote storage module 228 transfers application data 231 to a remote server, such as the application delivery server 138. The remote server stores the application data 231. Later, if a user wishes to re-install the application to the same device (or, in some embodiments, to other devices), the application data 231 is automatically retrieved from the server and stored in memory 244 on the mobile device 201 so that it is accessible by the re-installed application. In another scenario, a user may backup application data 231 to a server, such as the application delivery server 138, in order to transition to a different mobile device 201. For example, a user may purchase a new mobile device 201 (which will be called a “second device”) and may wish to use the same applications, with at least some of the same application data 231, on the new device which were previously installed on the old device 201 (which will be called a “first device”). The remote storage module 228 may allow a user to initiate a transfer of the application data 231 associated with an application from the first device to the server (i.e. the application data 231 may be backed up to the server). The second device 201, which may also include the features discussed with respect to FIG. 2, may, automatically or at the request of the user via the input mechanism, retrieve and install one or more applications which were previously installed on the first device 201. That is, the second device 201 may request such applications from the application delivery server 138. Upon receiving a request from the new device 201 for the application, the application delivery server 138 may automatically transfer the application and the associated application data 231 to the second device 201. The second device 201 may automatically save the application data 231 to its memory 244.

The serial data port 252 may be used for synchronization with a user's host computer system (not shown). The serial data port 252 enables a user to set preferences through an external device or software application and extends the capabilities of the mobile communication device 201 by providing for information or software downloads to the mobile communication device 201 other than through the wireless network 101. The alternate download path may, for example, be used to load an encryption key onto the mobile communication device 201 through a direct, reliable and trusted connection to thereby provide secure device communication.

In some example embodiments, the mobile communication device 201 is provided with a service routing application programming interface (API) which provides an application with the ability to route traffic through a serial data (i.e., USB) or Bluetooth® (Bluetooth® is a registered trademark of Bluetooth SIG, Inc.) connection to the host computer system using standard connectivity protocols. When a user connects their mobile communication device 201 to the host computer system via a USB cable or Bluetooth® connection, traffic that was destined for the wireless network 101 is automatically routed to the mobile communication device 201 using the USB cable or Bluetooth® connection. Similarly, any traffic destined for the wireless network 101 is automatically sent over the USB cable Bluetooth® connection to the host computer system for processing.

The mobile communication device 201 also includes a battery 238 as a power source, which is typically one or more rechargeable batteries that may be charged, for example, through charging circuitry coupled to a battery interface such as the serial data port 252. The battery 238 provides electrical power to at least some of the electrical circuitry in the mobile communication device 201, and the battery interface 236 provides a mechanical and electrical connection for the battery 238. The battery interface 236 is coupled to a regulator (not shown) which provides power V+ to the circuitry of the mobile communication device 201.

The short-range communication subsystem 272 is an additional optional component which provides for communication between the mobile communication device 201 and different systems or devices, which need not necessarily be similar devices. For example, the subsystem 272 may include an infrared device and associated circuits and components, or a wireless bus protocol compliant communication mechanism such as a Bluetooth® communication module to provide for communication with similarly-enabled systems and devices.

A predetermined set of applications that control basic device operations, including data and possibly voice communication applications will normally be installed on the mobile communication device 201 during or after manufacture. Additional applications and/or upgrades to the operating system 222 or software applications 224 may also be loaded onto the mobile communication device 201 through the wireless network 101, the auxiliary I/O subsystem 250, the data port 252, the short-range communication subsystem 272, or other suitable subsystem 274 other wireless communication interfaces. The downloaded programs or code modules may be permanently installed, for example, written into the program memory (i.e. the flash memory 244), or written into and executed from the RAM 246 for execution by the processor 240 at runtime. Such flexibility in application installation increases the functionality of the mobile communication device 201 and may provide enhanced on-device functions, communication-related functions, or both. For example, secure communication applications may enable electronic commerce functions and other such financial transactions to be performed using the mobile communication device 201.

The mobile communication device 201 may provide two principal modes of communication: a data communication mode and an optional voice communication mode. In the data communication mode, a received data signal such as a text message, an email message, or Web page download will be processed by the communication subsystem 211 and input to the processor 240 for further processing. For example, a downloaded Web page may be further processed by a browser application or an email message may be processed by an email message application and output to the display 242. A user of the mobile communication device 201 may also compose data items, such as email messages, for example, using the touch-sensitive overlay 206 in conjunction with the display device 204 and possibly the control buttons 260 and/or the auxiliary I/O subsystems 250. These composed items may be transmitted through the communication subsystem 211 over the wireless network 101.

In the voice communication mode, the mobile communication device 201 provides telephony functions and operates as a typical cellular phone. The overall operation is similar, except that the received signals would be output to the speaker 256 and signals for transmission would be generated by a transducer such as the microphone 258. The telephony functions are provided by a combination of software/firmware (i.e., the voice communication module) and hardware (i.e., the microphone 258, the speaker 256 and input devices). Alternative voice or audio I/O subsystems, such as a voice message recording subsystem, may also be implemented on the mobile communication device 201. Although voice or audio signal output is typically accomplished primarily through the speaker 256, the display device 204 may also be used to provide an indication of the identity of a calling party, duration of a voice call, or other voice call related information.

Referring now to FIG. 3, an application delivery server 138 for use in accordance with one example embodiment of the present disclosure will now be described in greater detail. The application delivery server 138 may be implemented using any known general purpose computer technology, and may, for example, be realized as one or more microprocessor based server computers implementing one or more server applications configured for performing the processes and functions described herein.

The application delivery server 138 may include one or more controller, such as a processor 340 for controlling the overall operation of the server 138. The application delivery server 138 may communicate with other devices connected to the network 124 through a communication subsystem and network interface 320. For example, the application delivery server 138 may communicate with the mobile devices 201 (FIG. 1) via the wireless connector system 120 (FIG. 1). The application delivery server 138 has access to a data store 332 which may be local to the server 138 or remote from the server 138. The data store 332 contains applications 334 which are available for download, application data, and application information 336 describing the applications available for download, and application history information 338 identifying the applications 334 that a user or mobile device 201 has access to. That is, the application history information 338 identifies the applications 334 each user, account, or mobile device 201 is permitted to re-download.

The processor 340 of the application delivery server 138 operates under stored program control and executes software modules 322 stored in memory 344 such as persistent memory; for example, on a hard disk drive. As illustrated in FIG. 3, the software modules 322 include an application store module 326 for interfacing with the application store client 226 (FIG. 2) and remote storage module 228 on the mobile communication devices 201 and providing for the download, backup, re-download, and/or purchase of software applications 334.

In some example embodiments, the application store module 323 permits users of mobile devices 201 to purchase and download applications for use on the mobile devices 201. The application store module 323 of the application delivery server 138 includes an application delivery module 326 for receiving a request from a mobile device 201 for delivering an application to the mobile device 201, retrieving the application 334 from a data store 332, and transmitting the application 334 to the mobile communication device 201. In some example embodiments, the application delivery module 326 may process a payment for an application 334. For example, the application delivery module 326 may post a charge to an account associated with the mobile communication device 201 or its user or process a credit card transaction. The application store module may act as a remote storage module, allowing users or mobile devices 201 to retrieve and download previously purchased applications 334.

To provide such remote storage capabilities, after transmitting the application 334 to the mobile device and/or processing a payment associated with the application transfer, the application store module 323 creates a record of the purchase or download by updating the application history information 338 associated with the user. The application history information 338 specifies the applications 334 that are available for a user or mobile device 201 to re-download at a later time. Each user or mobile device 201 which has purchased an application 334 through the application store 323 has application history information 338 associated with that user. The application history information 338 may be, for example, stored in one or more databases which may be indexed by an identifier associated with the user or the mobile device 201. For example, the database may be indexed by the PIN 241 associated with the mobile device 201. The application history information 338 includes data relating to previously purchased applications. For example, the application history information 338 may include an identifier associated with and identifying applications which were previously purchased, a version number associated with the application, a record of the total number of downloads of an application 334 since it was purchased or over a predetermined period of time. For example, the application history information 338 may track the number of times a user has downloaded an application 334 in the past year. In some example embodiments, if the total number of downloads reaches or exceeds a predetermined threshold which specifies the amount of downloads available to a user or device 201, the application store module 323 may prevent the re-downloading of the application 334.

Accordingly, each user or mobile device 201 may have an application history information 338 record specifying an application purchase or download history for that user. As will be explained in greater detail below, this application history information 338 may be used to provide remote storage capabilities to the mobile device 201, permitting a user to re-download previously purchased applications.

The application delivery module 326 transmits, to the mobile device 201 information specifying the applications 334 which are available for re-download. For example, the application delivery module 326 may determine, from the application history information 338, the applications that are available for download to the mobile device 201 and notify the mobile device 201 of details of the applications 334 that are available for re-download. By way of non-limiting example, these details may include: the name of the application, a version number associated with the application, a date of purchase of the application, and other application information 336 regarding the application such as a description of the application.

Later, the application delivery module 326 may receive a request from the mobile device 201 to re-download an application. The application delivery module 326 retrieves the requested application 334 and transmits it to the mobile device 201. In some example embodiments, the application delivery module 326 may be configured to record details of the re-download to the application history information 338 record associated with the mobile device 201 or user making the download request.

In some example embodiments, the application delivery server 138 includes a backup module 353 which is configured to facilitate the backup of application data 231. In the example embodiment of FIG. 3, the backup module 353 is illustrated as being included within the application store module 323. However, it will be appreciated that the backup module 353 could be located in other modules and may, in at least some example embodiments, be located in a server that is physically separate from the application delivery server 138.

As will be explained in greater detail below with respect to FIGS. 6 and 7, in some example embodiments, the backup module 353 may provide for the backup and restoration of application data 231 received from one or more mobile device 201. The mobile device 201 may transfer application data 231 associated with one or more application to the application delivery server 138.

The mobile device 201 may transfer application data 231 to the server 138 in response to the occurrence of one or more predetermined trigger events. The trigger event may be, for example, one or more of the following: the receipt of a request to delete the application associated with the application data 231, the deletion of the application associated with the application data 231 from the memory 244, a request received via an input mechanism to backup the application data 231, or the receipt of a request to switch to a different device, such as a new device. Other trigger events are also possible.

The backup module 353 may be configured to store the application data 231 in memory 344.

Later, the application data 231 may be transferred to a mobile device 201. In some example embodiments, the application data 231 may be transmitted to a mobile device 201 if a request to reinstall the application associated with the application data 231 is received from the same device 201 or user or a user or device associated with the same account. When such a request is received the application delivery module 326 may transfer the application to the requesting device 201 and the backup module 353 may retrieve the associated application data 231 and transmit it to the requesting device 201.

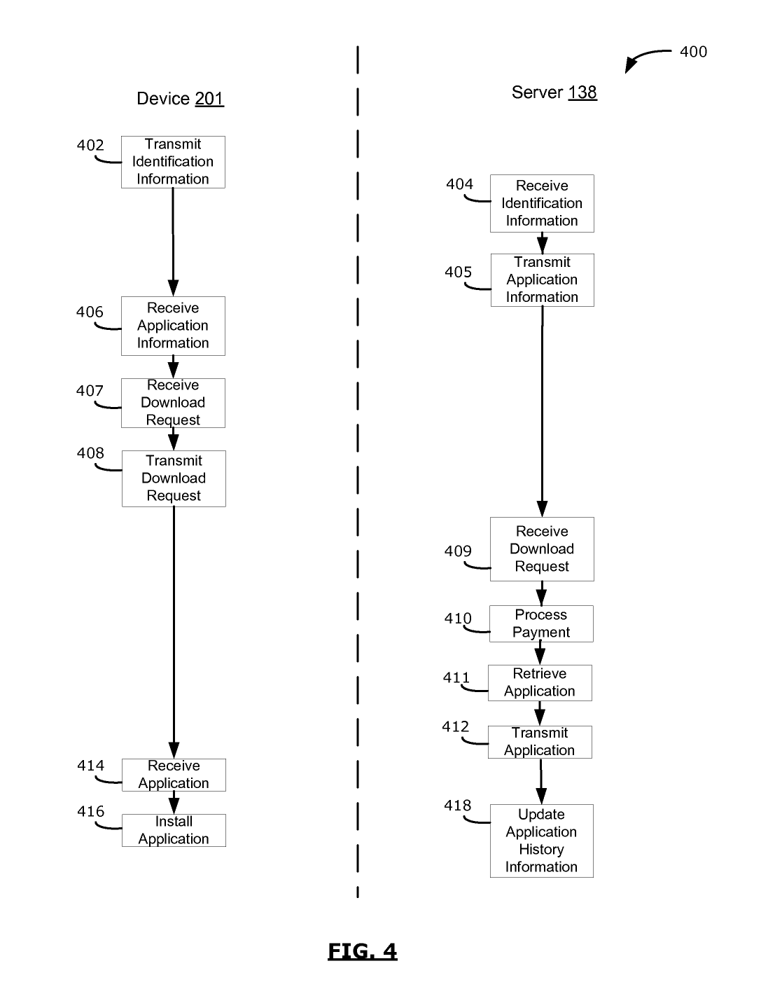

An overview having been provided, reference is now made to FIG. 4 which illustrates a method 400 for providing an application 334 to a mobile communication device 201 in accordance with one example embodiment of the present disclosure. The method 400 includes steps or operations performed by the requesting device, such as the mobile device 201 (FIG. 2), and steps or operations which are performed by one or more server, which may be, or which may include, the application delivery server 138 (FIG. 3). The application store module 323 (FIG. 3) may be configured to perform the server specific steps or operations of the method 400 and the application store client 226 (FIG. 2) of the mobile device 201 may be configured to perform the mobile device specific steps or operations of the method 400.

At step 402, the mobile device 201 may transmit identification information which is received at the application delivery server 138 at step 404. In some example embodiments, the identification information may relate to the identity of the mobile communication device 201. For example, the identification information may be a PIN 241 associated with the mobile device 201. In other example embodiments, the identification information may relate to the identity of the user of the mobile device. For example, the user may log in to an application store client 226 on the mobile device using a username and password and the identification information may be the username and password. In other example embodiments, the identification information may be an account name or number associated with the user. The identification information may, in some example embodiments, be transmitted when a user loads the application store client application 226 on their mobile device 201. In other example embodiments, identification information is transmitted with each exchange of information between the mobile device 201 and the application delivery server 138. The identification information may be sued to track the purchase of applications by the mobile device 201 or the user of the mobile device 201.

At step 405, the application delivery server 138 may retrieve and transmit application information 336 to the mobile communication device 201. The application information may include information describing one or more applications 334. It may include information, such as, for example, a description of the functions provided for by the application 334, a price associated with the application 334, user or critic generated reviews of the application 334, a release date associated with the application 334, and an identifier associated with the application 334. The application information 336 may, in some instances be transmitted based on search parameters provided by the user of the mobile device 201. For example, the mobile device user may request information relating to applications corresponding to a specific keyword or applications of a specific type; for example, games. In response to receiving such a request, the application delivery server 138 may retrieve application information 336 corresponding to applications 334 meeting the desired criteria and transmit that application information 336 to the mobile device 201.

The application information 336 is received by the mobile device 201 at step 406. The mobile device 201 may display at least some of the application information 336 to the user of the mobile device 201 using the display 204. An option to purchase or download the application 334 associated with the application information 336 may also be presented on the display 204. Using an input mechanism such as, for example, the touchscreen display 210, the control keys 260 or another input mechanism, a user may request the purchase or download of an application 334 associated with the application information 336 (Step 407).

After receiving a request from the user to purchase or download the application, the mobile device 201 may transmit a request (step 408) to the application delivery server 138 to request the transfer of the specified application 334 to the mobile communication device 201. The request may include information identifying the application 334 that the request relates to; such as, for example, an identifier associated with the application 334. The request is received at the application delivery server 138 at step 409.

The application delivery server 138 may process a payment for the application 334 at step 410. This may be done, for example, by charging a credit card or account associated with the user or the mobile device 201.

Next, at step 411, the application 334 associated with the download request is retrieved from a data store 332 and transmitted to the mobile device 201 at step 412. The application 334 is received at the mobile device 201 at step 414 and may be installed to the mobile device 416 at step 416. In some example embodiments, the application 334 is automatically installed to the mobile device 201 after it is received. That is, in some example embodiments, additional input from the user is not required in order to initiate installation. Installation includes steps which are necessary or desirable to prepare the application 334 for use including, for example, decompressing the received application 334, placing a desktop icon on a home page of a graphical user interface associated with the mobile device 201 so that the user may launch the application 334, and creating a space to store files associated with the application 334, such as one or more folders.

After either the payment for the application 334 has been processed at step 410 or the application has been transmitted to the mobile device 201 at step 412, the application history information 338 for the user or the user's mobile device 201 is updated to reflect the purchase and/or download of the application 334 (step 418). Thus a record is maintained which permits the application store module 323 to track the applications 334 which have been downloaded or purchased by a specific user or a specific device 201.

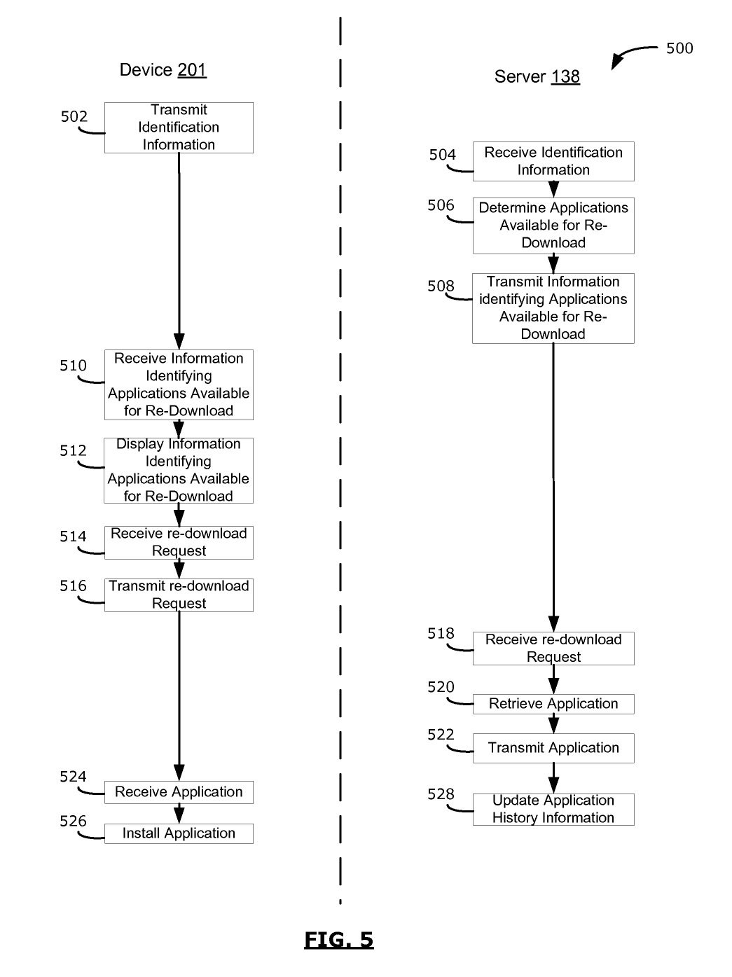

At some point following the purchase or download of the application 334, a user may delete the application 334 from the mobile device or may switch to a new mobile device 201 which does not have the application 334 installed thereon. The user may wish to re-install the application onto the mobile device 201. The user's mobile device 201 may re-download the application according to following method 500, which will be discussed with reference to FIG. 5. The method 500 includes steps or operations performed by the requesting device, such as the mobile device 201 (FIG. 2), and steps or operations which are performed by the application delivery server 138 (FIG. 3). The application store module 323 (FIG. 3) may be configured to perform the server specific steps or operations of the method 500 and the remote storage module 228 (FIG. 2) of the mobile device 201 may be configured to perform the mobile device specific steps or operations of the method 500.

At step 502, the mobile device 201 may transmit identification information. In some example embodiments, the identification information may relate to the identity of the mobile communication device. For example, the identification information may be a PIN 241 associated with the mobile device 201. In other example embodiments, the identification information may relate to the identity of the user of the mobile device. For example, the user may log in to the application store client 226 or the remote storage module 228 on the mobile device using a username and password and the identification information may be the username and password. In other example embodiments, the identification information may be an account name or number associated with the user. The identification information may, in some example embodiments, be transmitted when a user loads the application store client application 226 on their mobile device 201. In other example embodiments, identification information is transmitted with each exchange of information between the mobile device 201 and the application delivery server 138. The identification information is received at the application delivery server 138 at step 504.

At step 506, the identification information is used to determine the applications 334 that are available for re-download to the mobile device 201. The application delivery module 326 of the application store 323 determines the applications 334 that are associated with the mobile device 201 or the user which is related to the received identification information. The application delivery module 326 may make this determination by retrieving the application history information 338 associated with the user or device 201 from the data store 332. The application history information 338 specifies the applications 334 that were previously downloaded or purchased by the user or mobile device 201 making the request. Applications 334 which were previously purchased by the user, or which were previously downloaded to the mobile device 201 may be considered re-downloadable applications.

In some example embodiments, the application history information 338 may include access restrictions associated with an application 334. The application delivery module 326 may be configured to examine the access restrictions in order to determine whether an application 334 is available for re-download. The access restrictions may specify limitations restricting the re-downloading of the application 334. For example, the access restrictions may specify a period of time during which the application 334 is available for re-download following its purchase. For example, the access restrictions may specify that an application is only available for download for one year following its purchase. In other example embodiments, the access restrictions may relate to a total number of times that the application is available for re-download to a user.

At step 508, the application delivery module 326 of the application delivery server 138 transmits information regarding the applications which are available for re-download to the mobile device 201. This information may include, for example, one or more of: the name of the applications 334, a description of the functions provided for by the applications 334, user or critic generated reviews of the applications 334, a release date associated with the applications 334, a date on which the applications were purchased, and identifiers associated with the applications 334. This information may be retrieved from one or both of the application history information 338 and the application information 336 of the data store 332 of the application delivery server 138.

The information regarding the applications 334 which are available for re-download is received at the mobile communication device 201 at step 510. The remote storage module 228 of the mobile device 201 may display at least some of the information regarding the applications which are available for re-download at step 512. The displayed data may be presented in a list format in some example embodiments. The list may include two or more applications which are available for re-download to the mobile device 201. That is, a plurality of re-downloadable applications may be displayed on a single display screen, permitting a user to select one or more applications for re-download. Thus, a user may easily view all of the applications available for re-download, or a subset thereof.

Next, at step 514, a user may request that an application be re-downloaded to the mobile device 201 using an input mechanism associated with the mobile device; for example, the touchscreen display 210 or the control keys 260. The user may navigate to a desired application and select a “download,” “restore,” or other option to initiate the re-downloading of the application.

At step 516, the remote storage module 228 on the mobile device 201 transmits a request to the application delivery server 138 to re-download at least one application 334. The request includes information identifying the application 334 that the request relates to, such as, for example, an identifier associated with the application 334. The request is received at the application delivery server 138 at step 518.

At step 520, the application 334 specified in the request is retrieved by the application delivery server 138 from local or remote data storage. Then, at step 522, the application is transmitted to the mobile device 201 and is received at the mobile device 201 at step 524.

In some example embodiments, as represented in step 526 of FIG. 5, the application may be installed to the mobile device 201. The installation of the application may, in some example embodiments, be user-initiated. In other example embodiments, installation occurs automatically. In such example embodiments, after the user requests the re-downloading of the application using an input mechanism at step 407, no additional user input may be required to initiate the installation of the application 334.

In some example embodiments, at step 528, after the application delivery server 138 transmits the application 334, it may update the application history information 338 associated with the user or mobile device which re-downloaded the application. For example, the application delivery server 138 may update the application history information 338 to indicate the date and/or time of the download. In some example embodiments, the application history information 338 may include a count of the number of times each application has been downloaded or re-downloaded. In such example embodiments, the application delivery server 138 may increment the count. Should the count ever exceed a pre-determined threshold, the application delivery server 138 may be configured to no-longer permit the user or mobile device 201 to re-download the application 334. In some example embodiments, if the pre-determined threshold is exceeded, the application 334 may be removed from the user's list of applications available for re-download in the application history information 338. The count may be configured to reset after a predetermined period of time or to ignore prior downloads which occurred at a date which was greater than a predetermined period of time. For example, the count may only track the number of downloads in the last year. Once a year has past following the download, the count may be adjusted so that the year-old download is no longer considered in the count. It will be appreciated that the one-year threshold is merely illustrative and that other periods of time may be considered. In some example embodiments, the application delivery server 138 may only permit a user or mobile device 201 to download an application three times in a year.

In some example embodiments, the system 100 (FIG. 1) may provide for the backup of application data 231 (FIG. 2) associated with an application. The application data 231 may define settings, achievements, preferences, or other variable features with respect to an associated application. The application data 231 is data which is related to the application but which is typically generated, at least in part, on the mobile device 201.

When a user wishes to install an application to a mobile device 201 from which the application was previously deleted, or another device associated with the same user or account as the mobile device 201 from which the application was deleted, the user may wish to restore application data 231 related to the application. Accordingly, some example embodiments provide for the backup and restoration of application data 231.

An overview having been provided, reference is now made to FIG. 6 which illustrates a method 600 for backup up application data 231 from a mobile communication device 201 in accordance with one example embodiment of the present disclosure. The method 600 includes steps or operations performed by the mobile device 201 (FIG. 2), and steps or operations which are performed by one or more server, which may be, or which may include, the application delivery server 138 (FIG. 3) or another server having backup capabilities, such as a backup server (not shown). In some example embodiments, the backup module 353 (FIG. 3) may be configured to perform the server specific steps or operations of the method 600 and the remote storage module 228 (FIG. 2) of the mobile device 201 may be configured to perform the mobile device specific steps or operations of the method 400. It will be appreciated, however, that the functions may be divided into other modules or sub-modules, or servers.

First, at step 602, in some example embodiments, a request may be received to delete an application from the mobile device 201. The request may be received, for example, from an input mechanism associated with the mobile device 201. For example, a user interact with the input mechanism to select or activate a “delete”, “archive”, or other similar option in order to initiate the method 600.

In response to the receipt of the request to delete the application, at step 602, the mobile device 201 may send identification information to the application delivery server 138, or other backup server. The identification information may, in some example embodiments, identify the mobile device 201. For example, the identification information may be a Personal Identification Number (“PIN”) 241 associated with the mobile device 201. In other example embodiments, the identification information may identify a user or account associated with the mobile device 201. For example, the identification information may include one or more of a username and/or password, log-in information associated with the user or account, a unique identification number associated with the user or account, or an email address associated with the user or account.

In response to the receipt of the request to delete the application, at step 604, the mobile device 201 may also send application data 231 associated with the application related to the deletion request to a remote server, such as the application delivery server 138 or other backup server.

The identification information is received at the server at step 606 and the application data 231 is received at the server at step 608.

The identification information and the application data 231 are sent in such a manner that the server 138 is able to associate the received application data 231 with the identification information. That is, the server 138 is able to determine, from the identification information, the identity of a mobile device 201 an account, and/or a user associated with the application data 231.

It will be appreciated that various techniques may be employed in order to transmit the application data 231 to the server in such a way that the application data 231 may be associated with a specific device 201, account, and/or user. For example, in some embodiments, the application data 231 may be bundled with the identification information and sent together to the server.

In response to the receipt of the application data 231, the server 138 may store the application data to memory 344 at step 610. For example, the server may store the application data 231 to the data store 332 of memory 344.

The application data 231 may be stored in a manner in which it is specifically attributed to a specific user, account, device 201 and/or identification information. For example, in some example embodiments, the application data 231 may be stored and linked to the user, account, and/or device 201 defined by the identification information received at step 606. In at least some example embodiments, a database may be employed to associate application data 231 with a user, device, account and/or identification information.

Also in response to the receipt of the request to delete the application received at step 602, at step 612, the mobile device 102 may remove the application from the memory 244 of the mobile device 102.

At step 614, after the mobile device has transmitted the application data 231 to the server 138, in at least some example embodiments, it may delete the application data 231 from the memory 244 of the mobile device 201.

It will be appreciated that other methods of archiving application data 231 which differ from the example embodiment of FIG. 6 may also be used in other example embodiments. For example, in some example embodiments, application data 231 may periodically be backed up to a remote server, such as the application delivery server 138. In other example embodiments, the application data 231 may be archived or backup up to a remote server in response to a specific user-generated request to backup or archive the application data. A user may input such a request via an input mechanism associated with the mobile device; for example, a user may engage an input mechanism to select a “backup application data” option or another similar option.

At some point following the backup or archiving of application data 231, a user may wish to restore the application data 231 to a mobile device 201.

Referring to FIG. 7, an example embodiment of a method 700 which provides for retrieval of application data 231 is illustrated. The method 700 is similar to the method 500 of FIG. 5, except in that it further provides for the retrieval and restoration of application data 231 on the mobile device.

At some point following the deletion of an application according to the method of FIG. 6 (or another similar method), or at some point when a user acquires a new device 201 which does not have the application 334 installed thereon, the method 700 may be performed.

The user's mobile device 201 may re-download the application according to following method 700. The method 700 includes steps or operations performed by the requesting device, such as the mobile device 201 (FIG. 2), and steps or operations which are performed by the application delivery server 138 (FIG. 3) or by another server. The application store module 323 and/or the backup module 353 (FIG. 3) may be configured to perform the server specific steps or operations of the method 700 and the remote storage module 228 (FIG. 2) of the mobile device 201 may be configured to perform the mobile device specific steps or operations of the method 700. It will, however, be appreciated that the functions described below may be performed by other modules, sub-modules, or servers.

At step 702, the mobile device 201 may transmit identification information. In some example embodiments, the identification information may relate to the identity of the mobile communication device. For example, the identification information may be a PIN 241 associated with the mobile device 201. In other example embodiments, the identification information may relate to the identity of the user of the mobile device. For example, the user may log in to the application store client 226 or the remote storage module 228 on the mobile device using a username and password and the identification information may be the username and password. In other example embodiments, the identification information may be an account name or number associated with the user. The identification information may, in some example embodiments, be transmitted when a user loads the application store client application 226 on their mobile device 201. In other example embodiments, identification information is transmitted with each exchange of information between the mobile device 201 and the application delivery server 138. The identification information is received at the application delivery server 138 at step 704.

At step 706, the identification information is used to determine the applications 334 that are available for re-download to the mobile device 201. The application delivery module 326 of the application store 323 determines the applications 334 that are associated with the mobile device 201 or the user which is related to the received identification information. The application delivery module 326 may make this determination by retrieving the application history information 338 associated with the user or device 201 from the data store 332. The application history information 338 specifies the applications 334 that were previously downloaded or purchased by the user or mobile device 201 making the request. Applications 334 which were previously purchased by the user, or which were previously downloaded to the mobile device 201 may be considered re-downloadable applications.

In some example embodiments, the application history information 338 may include access restrictions associated with an application 334. The application delivery module 326 may be configured to examine the access restrictions in order to determine whether an application 334 is available for re-download. The access restrictions may specify limitations restricting the re-downloading of the application 334. For example, the access restrictions may specify a period of time during which the application 334 is available for re-download following its purchase. For example, the access restrictions may specify that an application is only available for download for one year following its purchase. In other example embodiments, the access restrictions may relate to a total number of times that the application is available for re-download to a user.

At step 708, the application delivery module 326 of the application delivery server 138 transmits information regarding the applications which are available for re-download to the mobile device 201. This information may include, for example, one or more of: the name of the applications 334, a description of the functions provided for by the applications 334, user or critic generated reviews of the applications 334, a release date associated with the applications 334, a date on which the applications were purchased, and identifiers associated with the applications 334. This information may be retrieved from one or both of the application history information 338 and the application information 336 of the data store 332 of the application delivery server 138.

The information regarding the applications 334 which are available for re-download is received at the mobile communication device 201 at step 710. The remote storage module 228 of the mobile device 201 may display at least some of the information regarding the applications which are available for re-download at step 712. The displayed data may be presented in a list format in some example embodiments. The list may include two or more applications which are available for re-download to the mobile device 201. That is, a plurality of re-downloadable applications may be displayed on a single display screen, permitting a user to select one or more applications for re-download. Thus, a user may easily view all of the applications available for re-download, or a subset thereof.

Next, at step 714, a user may request that an application be re-downloaded to the mobile device 201 using an input mechanism associated with the mobile device; for example, the touchscreen display 210 or the control keys 260. The user may navigate to a desired application and select a “download,” “restore,” or other option to initiate the re-downloading of the application.

At step 716, the remote storage module 228 on the mobile device 201 transmits a request to the application delivery server 138 to re-download at least one application 334. The request includes information identifying the application 334 that the request relates to, such as, for example, an identifier associated with the application 334. The request is received at the application delivery server 138 at step 718.

At step 720, the application 334 specified in the request is retrieved by the application delivery server 138 from local or remote data storage. Then, at step 722, the application is transmitted to the mobile device 201 and is received at the mobile device 201 at step 724.

In some example embodiments, as represented in step 726 of FIG. 7, the application may be installed to the mobile device 201. The installation of the application may, in some example embodiments, be user-initiated. In other example embodiments, installation occurs automatically. In such example embodiments, after the user requests the re-downloading of the application using an input mechanism at step 407, no additional user input may be required to initiate the installation of the application 334.

In response to receiving the request to download the application, the application delivery server 138 may, at step 728, determine whether application data 231 associated with the application 334 and associated with the requesting user, account, device 201, or with the identification information received at step 704, is stored in memory 344.

In some example embodiments, at step 728, the application delivery server 138 may determine whether there exists application data 231 in the memory 344, which is associated with same device that made the download request at step 714 and which is associated with the same application. That is, in some example embodiments, application data 231 will only be provided to the requesting device, if it is determined that the requesting device is the same device as the mobile device from which the application data 231 was received (for example at step 606 of FIG. 6). This determination may be made, in some example embodiments, based on the identification information received at step 704.

In other example embodiments, at step 728, the application delivery server 138 may determine whether there exists application data 231 that is associated with the same account as the account associated with the download request at step 714 and which is associated with the same application. That is, in some example embodiments, application data 231 will only be provided if it is determined that the requesting device is associated with an account that is the same as the account associated with the application data 231. This determination may be made, in some example embodiments, based on the identification information received at step 704.

If application data 231 satisfying the criteria noted in the preceding paragraphs is stored in memory 344, at step 730, the application data 231 is retrieved from memory 344 and, at step 732, the application data is sent to the mobile device 201.

The application data 734 is received by the mobile device 201 at step 734 and is stored in the memory 244 of the mobile device 201 at step 736.

In some example embodiments, at step 738, after the application delivery server 138 transmits the application 334, it may update the application history information 338 associated with the user or mobile device which re-downloaded the application. For example, the application delivery server 138 may update the application history information 338 to indicate the date and/or time of the download. In some example embodiments, the application history information 338 may include a count of the number of times each application has been downloaded or re-downloaded. In such example embodiments, the application delivery server 138 may increment the count. Should the count ever exceed a pre-determined threshold, the application delivery server 138 may be configured to no-longer permit the user or mobile device 201 to re-download the application 334. In some example embodiments, if the pre-determined threshold is exceeded, the application 334 may be removed from the user's list of applications available for re-download in the application history information 338. The count may be configured to reset after a predetermined period of time or to ignore prior downloads which occurred at a date which was greater than a predetermined period of time. For example, the count may only track the number of downloads in the last year. Once a year has past following the download, the count may be adjusted so that the year-old download is no longer considered in the count. It will be appreciated that the one-year threshold is merely illustrative and that other periods of time may be considered. In some example embodiments, the application delivery server 138 may only permit a user or mobile device 201 to download an application three times in a year.

In accordance with further example embodiments of the present disclosure, there are provided a computer program product including a computer readable medium having stored thereon computer executable instructions including instructions for practising the methods of the application.

The term “computer readable medium” as used herein means any medium which can store instructions for use by or execution by a computer or other computing device including, but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

While the present disclosure is primarily described as a method, a person of ordinary skill in the art will understand that the present disclosure is also directed to various apparatus such as a mobile communication device and wireless connector system for carrying out at least some of the aspects and features of the described methods and including components for performing at least some of the described method steps, be it by way of hardware components, a computer programmed by appropriate software to enable the practice of the disclosed method, by any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the disclosed method. It is understood that such apparatus, articles of manufacture, and computer data signals also come within the scope of the present disclosure.

FIGS. 4-7 are flowcharts of example embodiment methods for obtaining and delivering a software application, re-delivering a software application, and backing up application data. Some of the steps illustrated in the flowcharts may be performed in an order other than that which is described. Also, it should be appreciated that not all of the steps described in the flow charts are required to be performed, that additional steps may be added, and that some of the illustrated steps may be substituted with other steps.

The embodiments of the present disclosure described above are intended to be examples only. Those of skill in the art may effect alterations, modifications and variations to the particular example embodiments without departing from the intended scope of the present disclosure. In particular, features from one or more of the above-described example embodiments may be selected to create alternate embodiments comprised of a sub-combination of features which may not be explicitly described above. In addition, features from one or more of the above-described example embodiments may be selected and combined to create alternate embodiments comprised of a combination of features which may not be explicitly described above. Features suitable for such combinations and sub-combinations would be readily apparent to persons skilled in the art upon review of the present disclosure as a whole. The subject matter described herein and in the recited claims intends to cover and embrace all suitable changes in technology.

What is claimed is:

1. A method of delivering an application from an application delivery server comprising:
receiving application data associated with an application from a first mobile communication device;
in response to receiving the application data, storing the application data in a memory;
receiving a request for the application from a second mobile communication device which is associated with the first mobile communication device; and
in response to receiving the request: retrieving the application associated with the request; sending the application to the second mobile communication device; retrieving the application data associated with the application; and sending the application data to the second mobile communication device.

2. The method of claim 1, further comprising, prior to retrieving the application data, determining that the first mobile communication device and the second mobile communication device are the same device.

3. The method of claim 1, further comprising, prior to retrieving the application data, determining that the first mobile communication device and the second mobile communication device are associated with a common account.

4. The method of claim 1, wherein the application data defines user preferences associated with the application.

5. The method of claim 1, further comprising, prior to receiving the request for one of the applications:
identifying, from application history information, applications which are available for re-download to the second mobile communication device; and
sending data identifying the applications available for re-download to the second mobile communication device.

6. The method of claim 5 wherein the application history information comprises at least one database specifying a purchasing history for a plurality of users and wherein identifying applications available for re-download includes identifying previously downloaded applications relating to an account associated with the second mobile communication device.

7. The method of claim 5 wherein the application history information comprises at least one database specifying a purchasing history for a plurality of mobile communication devices and wherein identifying applications available for re-download includes identifying previously downloaded applications relating to mobile communication devices associated with the second mobile communication device.

8. The method of claim 5, further comprising:
receiving identification information from the second mobile communication device and wherein identifying applications available for re-download comprises determining, from the identification information and the application history information, previously downloaded applications associated with the identification information, and wherein retrieving the application data associated with the application comprises retrieving application data associated with the identification information.

9. The method of claim 8, wherein the identification information is an identifier associated with the second mobile communication device.

10. The method of claim 8, wherein the identification information is log-in information associated with an account.

11. The method of claim 8, wherein the identification information is a unique identifier programmed into memory of the second mobile communication device by the mobile communication device manufacturer.

12. An application delivery server comprising:
a communication subsystem for communicating with at least one mobile communication device;
at least one memory for storing one or more applications and for storing application data; and
at least one controller for controlling the operation of the application delivery server, the at least one controller being configured to:
receive application data associated with one of more of the applications from one of the mobile communication devices;
in response to receiving the application data, store the application data in memory;
receive a request for one of the applications from one of the mobile communication devices; and
in response to receiving the request: retrieve the application associated with the request; send the application to the mobile communication device; retrieve application data associated with the application; and send the application data to the mobile communication device.

13. The application delivery server of claim 12, wherein the application data defines user preferences associated with the application.

14. The application delivery server of claim 12, wherein the at least one memory also stores application history information, and wherein the controller is further configured to, prior to receiving the request for one of the applications:
identify, from the application history information, applications which are available for re-download to one of the mobile communication devices; and
send data identifying the applications available for re-download to the mobile communication device.

15. The application delivery server of claim 14 wherein the application history information comprises at least one database specifying a purchasing history for a plurality of users and wherein identifying applications available for re-download includes identifying previously downloaded applications relating to an account associated with the mobile communication device.

16. The application delivery server of claim 14 wherein the application history information comprises at least one database specifying a purchasing history for a plurality of mobile communication devices and wherein identifying applications available for re-download includes identifying previously downloaded applications relating to the mobile communication device.

17. The application delivery server of claim 14 wherein the controller is further configured to: receive identification information from the mobile communication device and wherein identifying applications available for re-download comprises determining, from the identification information and the download history information, previously downloaded applications associated with the identification information, and wherein retrieving the application data associated with the application comprises retrieving application data associated with the identification information.

18. The application delivery server of claim 14 wherein the controller is configured to associate the application data with identification information related to the mobile communication device from which the application data was received, and wherein the controller is further configured to receive identification information from the mobile communication device making the request, and wherein retrieving application data associated with the application comprises retrieving application data that is associated with the received identification information.

19. The application delivery server of claim 17, wherein the identification information is an identifier associated with the mobile communication device.

20. The application delivery server of claim 17, wherein the identification information is log-in information associated with an account.
